(19) United States
(12) Patent Application Publication
(10) Pub. No.: US 2009/0194125 A1
(43) Pub. Date: Aug. 6, 2009

(54) ULTRASOUND HAIR TREATMENT

(75) Inventors: Daniel Griffith Anderson, Sudbury, MA (US); Amir Nashat, Newton, MA (US); Betty Yu, Cambridge, MA (US); Ross I. Runnion, Boston, MA (US); David Thomas Puerta, Melrose, MA (US)

Correspondence Address: FITZPATRICK CELLA HARPER & SCINTO, 30 ROCKEFELLER PLAZA, NEW YORK, NY, 10112, US

(73) Assignee: LIVING PROOF, INC., Cambridge, MA (US)

(21) Appl. No.: 12/301,416

(22) PCT Filed: May 31, 2007
(86) PCT No.: PCT/US07/70104

§ 371 Date: Mar. 30, 2009

Related U.S. Application Data
(60) Provisional application No. 60/810,111, filed on May 31, 2006.

(51) Int. Cl. A45D 7/00; A46B 15/00; A61Q 5/00; A46B 13/00

(52) U.S. Cl. 132/207; 15/21.1; 132/208; 601/2

(57) ABSTRACT

The present invention relates to methods for the ultrasound enhancement of hair treatments, and to compositions and kits relating to said method. The invention further relates to ultrasonic devices for use in the methods.

### RELATED APPLICATIONS

The present application claims priority under 35 U.S.C. § 119(e) to U.S. provisional patent application, U.S. Ser. No. 60/810,111, filed May 31, 2006; the entire contents of which is incorporated herein by reference.

### BACKGROUND OF THE INVENTION

The hair care industry has developed many products for the coloring and styling of hair. Many coloring methods which lighten hair color or dye hair rely on the use of strong oxidants such as bleach, hydrogen peroxide, potassium and sodium and ammonium salts of perborate, persulfate and percarbamate which oxidize the melanin pigment found in the middle of hair fibers. Methods for permanently curling hair usually require the application of reducing agents (e.g., thioglycolic acid or highly alkaline solutions) which break the cysteine bonds responsible for the hair's natural curliness and waviness followed by oxidizing treatments which restore cysteine bonds after a hair style has been applied.

One problem common to such methods of hair treatment is the required use of harsh chemicals designed to augment hair color and style and the negative effects that they may have on the treated hair fibers. While these methods have proven to be effective and exhibit long lasting effects, extended exposure to such chemicals can damage hair fibers and significantly alter how healthy they look and feel.

### SUMMARY OF THE INVENTION

Ultrasonic devices convey their parametrically-specific energies to a target via both direct sonication, in which transduced sound waves strike a surface directly, and cavitation within the transmitting medium. Cavitation is a phenomenon which occurs during low-frequency sonication and in a liquid medium of low viscosity. Microscopic vibrations of an ultrasound device in such a medium produce a cloud of tiny bubbles, which collapse quickly and cause force impacts on the target (e.g., hair) surface either through shockwaves or microjets. These impacts, though very small in size, generate powerful forces and high point temperatures. The cumulative effect of many such impacts produces effects proximal to and across the target surface. With regard to hair, such effects can include enhanced chemical reactivity, enhanced cuticular adhesion, enhanced cuticle permeability, and even distribution of the treatment over the hair fiber. Changes may also be induced within the fluid itself or upon particles suspended therein. In addition, it is believed (without being bound by theory) that by varying the degree of cavitation, chemical treatment conditions, and pretreatment conditions, a variety of styling and treatment effects may be produced with little damage to the hair fiber.

As described herein, it has been discovered that the use of ultrasound in conjunction with a treatment medium exhibits a clear advantage over traditional methods of hair treatment by producing a desired effect, e.g., curling, straightening, styling, changing the feel, changing the appearance, dyeing, or coloring hair, while requiring shorter treatment times and lower relative concentrations of necessary chemicals. In addition to being healthier for the hair fibers, shorter treatment times and lower chemical concentrations also reduce overall treatment cost, chemical waste, and potential hazards. For example, it has been shown as described herein that acceptable dye adhesion can be obtained using an ultrasound device without the use of developer or oxidizer pretreatments such as hydrogen peroxide and bleach up to three times faster than comparable salon methods and at color dilutions below standard salon concentrations.

The present invention relates to the use of ultrasound in conjunction with various hair treatment methods, e.g., for curling, straightening, dyeing, or coloring hair. In some embodiments, the invention allows for the use of traditional treatment methods at lower chemical concentrations and/or shorter treatment times, thereby reducing treatment costs and/or mitigating hair damage.

Furthermore, it may be possible to change a hair style many times in a short period, e.g., a day or a week. The process of setting and resetting waves and curls in the hair fibers is relatively quick and may be accomplished in a short amount of time.

In certain embodiments, the current invention allows the user to apply the treatment medium to all or a portion of the hair, style the hair, and then produce the desired effect by energizing the ultrasonic device. This approach differs from prior art approaches which dispense a treatment medium concurrently with production and application of ultrasonic energy.

The present invention relates to the use of an ultrasonic device in order to treat hair by applying a treatment medium to the hair and energizing an ultrasonic device in contact with the treatment medium and proximal to the treated hair. The treatment medium acts as a means for transferring an efficacious energy from the ultrasonic device to the hair, in turn allowing for the treatment of said hair in less time and/or with lower concentrations of chemicals than typical styling methods.

In certain embodiments, the invention relates to a method for treating hair comprising applying a combination of treatment mediums to said hair as a means of transferring an efficacious energy from an ultrasonic device to the hair. In some embodiments, the treatment mediums are basic solutions—a characteristic which helps lift the cuticle and facilitate dye penetration. In other embodiments, said treatment mediums comprise a surfactant or detergent which may help control the cavitation rate, thus preventing the production of localized pockets of excessive temperatures. These treatment mediums also aid in providing a uniform hair fiber surface for optimal chemical exposure and adhesion. In yet other embodiments, said treatment mediums comprise a basic solution including a surfactant or detergents. In certain embodiments, the treatment medium does not include a chelant or chelating agent.

In some embodiments, application of the energy emitted from the ultrasonic device to hair is accomplished via multiple acoustically-coupled articulations on an ultrasonic brush device. Such acoustic coupling transmits ultrasound both longitudinally along the backbone of said ultrasonic brush device and radially, relative to said backbone, via multiple appurtenances. Upon exposure, hair fibers are captured and converged into a regional conformation usefully proximate to the generated ultrasound such that said hair fibers are arranged in a way which provides a maximally efficient distribution of the desired effect.

In some embodiments, the ultrasonic device comprises a brush device. The ultrasonic brush device can be passed over hair exposed to a treatment medium thereby transferring ultrasound energy to said hair fibers.

In certain embodiments, the ultrasonic device comprises a 360° ultrasonic rod device. Hair fibers exposed to a treatment medium can be rolled over the cylindrical portion of the rod to transfer ultrasound energy to said hair fibers.

In some embodiments, the ultrasonic device generates and focuses a second field of ultrasound perpendicular to that produced by the brush backbone. Such a technique increases the surface area available for effective energy transmission with minimal energy loss due to reductive reflection affected by the design of said ultrasonic device and said treatment material.

In embodiments wherein the ultrasonic device comprises a 360° ultrasonic rod device, applying a topically efficacious energy from said 360° ultrasonic rod device to hair fibers via multiple transducers acoustically coupled to a multitude of appurtenances distributed across the surface of the cylindrical rod arranged produces a converging treatment region in 360° relative to the rod axis.

In another embodiment, the 360° ultrasonic rod device utilizes a mechanism comprising a conductive sheath around the center cylinder upon which microtransducers are affixed thus allowing for the free rotation of the 360° ultrasonic brush rod device around the center cylinder. In certain embodiments, ultrasonic transmittance can be achieved without causing any winding of keratinous fibers about the device. In another embodiment, the mechanism may be locked or unlocked by discretion giving the device a duality of function.

In certain embodiments, the ultrasonic device utilizes a transducer handle capable of accepting multiple attachments for different purposes. Such a handle fits into a coupling socket and is used either for transmitting previously transduced energy or for providing a power coupling which allows for transduction within the attachment rather than said handle. In particular embodiments, the device may have a reservoir for containing and dispensing hair treatment compositions, e.g., prior to activation of the device.

The invention further relates to a kit for the treatment of hair comprising an ultrasonic device and a treatment medium packaged together with instructions for use in hair treatment. The kit may include sufficient quantities of treatment medium for single or multiple treatments.

### DETAILED DESCRIPTION OF CERTAIN EMBODIMENTS OF THE INVENTION

As described herein, it has been discovered that the use of an ultrasonic device in combination with the application of a treatment medium to hair transfers an efficacious energy from the ultrasonic device to said hair which can effect the curling, straightening, feel, optical properties, and/or coloring of hair. In certain embodiments, the inventive treatment requires less time and/or with lower concentrations of chemicals than other styling methods. By varying the degree of cavitation, chemical treatment and pretreatment conditions, changes in the state or quality of hair may be induced that produce a desired effect with little damage to the hair fiber.

The treatment medium is applied to all or a portion of the hair that is to be treated, typically after the hair has been washed to remove any excess dirt or oils which may have accumulated. Application of the treatment medium to the hair can be accomplished by several means including, but not limited to, spraying, dipping, painting, washing, brushing, or combinations thereof. After the treatment medium has been applied, the ultrasonic device is energized in contact with the treatment medium and proximal to said hair and styled according to the preference of the user.

In certain embodiments, the applied treatment medium is basic. For example, the basic treatment medium may contain an organic or inorganic base. In certain embodiments, the basic treatment medium comprises a metal hydroxide. In certain embodiments, the applied treatment comprises a detergent or surfactant. In some embodiments, the applied treatment medium comprises sodium docecyl sulfate (SDS), potassium hydroxide (KOH), and/or sodium hydroxide (NaOH). The treatment medium may be an aqueous or alcoholic solution. In certain embodiments, the pH range of the treatment medium is from about 10 to about 13. In certain embodiments, the pH range is from about 10 to about 11.5. In certain embodiments, the pH range is from about 9 to about 10.

Accordingly, in some embodiments, the treatment medium is an alcoholic (e.g. ethanolic) or aqueous KOH treatment medium. The KOH treatment medium comprises from about 2.5% to about 4.5% KOH by weight and is preferably about 3.5% KOH by weight. In certain embodiments, the KOH treatment medium is an ethanolic KOH treatment medium.

In other embodiments, the SDS treatment medium comprises from about 3% to about 7% SDS by weight of the treatment medium and is preferably present at about 5%.

In other embodiments, the NaOH treatment medium comprises an aqueous or alcoholic solution with a concentration range from about 0.3 M to about 0.7 M NaOH and is preferably present at 0.5 M NaOH.

In certain embodiments, the ultrasonic device is operated at a frequency range from about 15 kHz to about 25 kHz. In a preferred embodiment, the ultrasonic device is operated at about 20 kHz. In certain embodiments, the frequency of operation of the device can be varied during operation, or the frequency can remain constant.

In some embodiments the hair is sonicated, after treatment with an appropriate treatment medium, for about 2 minutes to about 15 minutes. In certain embodiments, the treated hair is sonicated for about 5 minutes to about 10 minutes.

In other embodiments, the hair fiber is from about 2 mm to about 4 mm away from the ultrasonic device. In certain particular embodiments, the hair fiber is about 1 mm away from the ultrasonic device. In certain particular embodiments, the hair fiber is about 2 mm away from the ultrasonic device. In certain particular embodiments, the hair fiber is about 3 mm away from the ultrasonic device. In certain particular embodiments, the hair fiber is about 4 mm away from the ultrasonic device.

In some embodiments, the ultrasonic device is operated at an intensity range from about 40 W/cm² to about 55 W/cm². The intensity of operation of the device can be varied during operation or can remain constant.

The invention also relates to a method of treating hair comprising energizing an ultrasonic device which, when held proximal to hair treated with a treatment medium, transfers ultrasonic energy from the device to the hair. In some embodiments, the treatment affects the curliness, color, optical properties, shine, feel, texture, and style of the treated hair.

According to the invention, the use of treatment mediums of varying composition allows for greater control over the hair style generated. A treatment medium is any solution which, when applied to hair fibers, acts as a means of effectively transferring ultrasound energy from the ultrasonic device to said hair fibers. In some embodiments, the treatment medium comprises a solution comprising a detergent or surfactant. In other embodiments, the treatment medium comprises a basic solution. In yet another embodiment, said treatment medium comprises a basic solution with a detergent or surfactant.

In addition to acting as a means of effectively transferring ultrasound energy from the ultrasonic device to said hair fibers, treatment mediums may contain additives which impart an additional effect on the hair fibers. In an application in which the invention is used to treat damaged hair, for example, such additives may include, but are not limited to, vitamins, lipids, polymers, proteins, carbohydrates, and other compounds conducive to the health or healthy appearance of human hair. In another application of the invention, dyes or color lightening agents may be included in the treatment medium thus serving as a color treatment. In yet another application, perfumes or aromatic compounds may be included in the treatment medium thus serving as a means of adding a scent to the treated hair. Methods and compositions of the inventive system can also be used to treat hair contained in wigs. In other embodiments, the devices and methods of the invention can be used in conjunction with methods of hair treatment as described in U.S. provisional patent applications, U.S. Ser. Nos. 60/793,821, filed Apr. 21, 2006; 60/798,572, filed May 8, 2006; 60/799,825, filed May 11, 2006; 60/800,142, filed May 11, 2006; 60/800,143, filed May 11, 2006; 60/800,146, filed May 11, 2006; and 60/853,612, filed Oct. 23, 2006; each of which is incorporated herein by reference; U.S. patent application, U.S. Ser. No. 11/734,425, filed Apr. 12, 2007, which is incorporated herein by reference; and international PCT applications, PCT/US07/09083, filed Apr. 12, 2007; PCT/US07/68758, filed May 11, 2007; and PCT/US07/68751, filed May 11, 2007; each of which is incorporated herein by reference.

Desired physical characteristics of the treatment mediums for application to hair include good consistency, distributability, economical application, good definition, feel, and texture for treatment of hair, slight load, lack of residue, ease of shaping hair, and suitability for treatment of curly hair. In addition, when applied to the hair, said treatment mediums exhibit a smooth consistency and feeling on their hair and are not sticky or difficult to manipulate with a brush, comb, or ultrasonic device. In addition, the treatment medium should have an appropriate viscosity to effectively transfer the ultrasonic energy, i.e., to facilitate cavitation.

The invention also relates to kits comprising an ultrasonic device and a treatment medium packaged together with instructions for use in hair treatment. The compositions may be packaged as a lotion, styling lotion, gel, mousse, pumpable hair spray, pumpable spray setting, care spray, or styling spray. Suitable containers are well known in the art and include conventional, non-aerosol pump sprays, i.e., atomisers, aerosol containers, or cans having propellant and also pump aerosol containers utilizing compressed air as the propellant. The instructions will generally provide instruction for use in accordance with methods described herein.

The invention will be further exemplified by the following non-limiting examples.

### EXAMPLES

In this example, all sonication experiments are performed in a soundbox. A sample of human hair is placed on a standard hair roller and secured in a glass dish. The hair sample is then centered within 3 mm of the Branson Sonifer horn (250 A) and suspended in a solution of varying dilutions of SDS (5% w/v) and ethanol KOH (3.5% w/v). Samples were monitored at various points in the pH range of 10-13. A temperature probe is placed in the solution and the Sonifer is adjusted to the following settings: Frequency—fixed at 20 kHz, Intensity—level 10, Duty Cycle—100%. The hair is sonicated for various times (5-15 min). The repeatable results show that the hair can be modified (curled) at different degrees depending on the pH level and time of sonication.

### Equivalents

While specific embodiments of the subject inventions are explicitly disclosed herein, the above specification is illustrative and not restrictive. Many variations of the inventions will become apparent to those skilled in the art upon review of this specification and the claims below. The full scope of the inventions should be determined by reference to the claims, along with their full scope of equivalents, and the specification, along with such variations.

1. A method of treating a keratinous fiber comprising:
(a) applying a treatment medium to said keratinous fiber; and
(b) energizing an ultrasonic device in contact with said treatment medium and proximal to said keratinous fiber;
wherein said treatment medium facilitates energy transfer between said ultrasonic device and said treated keratinous fiber, and whereby said keratinous fiber is treated as a result of said energy transfer.

2. The method according to claim 1, wherein said ultrasonic device is an ultrasonic brush device comprising multiple acoustically-coupled articulations.

3. The method according to claim 1, wherein said treatment medium is effective in the straightening, rejuvenation, sealing, coating and coloring of said keratinous fibers.

4. The method according to claim 2, wherein acoustic coupling transmits ultrasound both longitudinally along the backbone of said ultrasonic brush device and radially, relative to said backbone via multiple appurtenances.

5. The method according to claim 1, wherein said keratinous fibers are captured and converged into a regional conformation usefully proximate to generated ultrasound such that said keratinous fibers are arranged in a way which provides a maximally efficient distribution of the desired effect.

6. The method according to claim 2, wherein said ultrasonic brush device generates and focuses a second field of ultrasound perpendicular to that produced by the brush backbone.

7. The method according to claim 6, wherein the surface area available for effective energy transmission with minimal energy loss due to reductive reflection affected by the design of said ultrasonic brush device and said treatment medium is increased.

8. The method according to claim 2, wherein said ultrasonic brush device utilizes a transducer handle capable of accepting multiple attachments for different purposes, fitting into a coupling socket either for transmitting previously transduced energy or for providing a power coupling allowing for transduction within the attachment rather than said handle.

9. The method according to claim 1, wherein said treatment medium is selected from the group consisting of SDS, ethanolic KOH and aqueous NaOH.

10. The method according to claim 1, wherein said treatment medium is a 3% to 7% SDS solution.

11. The method according to claim 1, wherein said treatment medium is a 5% SDS solution.

12. The method according to claim 1, wherein said treatment medium is a 2.5% to 4.5% solution of KOH in ethanol.

13. The method according to claim 1, wherein said treatment medium is a 3.5% solution of KOH in ethanol.

14. The method according to claim 1, wherein said treatment medium is 0.3M to 0.7M aqueous solution of NaOH.

15. The method according to claim 1, wherein said treatment medium is 0.5M aqueous solution of NaOH.

16. The method according to claim 9, wherein said treatment medium has a pH between 10-13.

17. The method according to claim 2, wherein said ultrasonic brush device is operated at about 20 kHz.

18. The method according to claim 2, wherein said keratinous fiber is within approximately 3 mm of the energized ultrasonic brush device.

19. The method according to claim 2, wherein said ultrasonic brush device is energized both concurrent with application of said treatment medium to said keratinous fiber and subsequent to application of said treatment medium to said keratinous fiber.

20. The method according to claim 1, wherein said keratinous fiber is treated for about 2-15 minutes.

21. The method according to claim 1, wherein said keratinous fiber is treated for about 5-10 minutes.

22. The method according to claim 1, wherein the time needed to achieve the desired styling effect is reduced by up to 67% compared to traditional styling methods.

23. The method according to claim 2, wherein said ultrasonic brush device is a 360° ultrasonic brush rod device.

24. The method according to claim 23, wherein said 360° ultrasonic brush rod device comprises multiple transducers acoustically coupled to a multitude of appurtenances distributed across the surface of the cylindrical rod arranged to produce a converging treatment region in 360° relative to the rod axis.

25. The method according to claim 23, wherein acoustic coupling transmits ultrasound both longitudinally and radially relative to the backbone of said 360° ultrasonic brush rod device via multiple appurtenances.

26. The method according to claim 23, wherein said keratinous fibers are captured and converged into a regional conformation usefully proximate to generated ultrasound such that said keratinous fibers are arranged in a way which provides a maximally efficient distribution of the desired effect.

27. The method according to claim 23, wherein said 360° ultrasonic brush rod device generates and focuses a second field of ultrasound perpendicular to that produced by the brush backbone.

28. The method according to claim 23, wherein the surface area available for effective energy transmission with minimal energy loss due to reductive reflection affected by the design of said ultrasonic brush device and said treatment medium is increased.

29. The method according to claim 23, wherein said 360° ultrasonic brush rod device utilizes a transducer handle capable of accepting multiple attachments for different purposes, fitting into a coupling socket either for transmitting previously transduced energy or for providing a power coupling allowing for transduction within the attachment rather than said handle.

30. The method according to claim 23, wherein said ultrasonic brush device is operated at about 20 kHz.

31. The method according to claim 23, wherein said keratinous fiber is within approximately 3 mm of the energized ultrasonic brush device.

32. The method according to claim 23, wherein said ultrasonic brush device is energized both concurrent with application of said treatment medium to said keratinous fiber and subsequent to application of said treatment medium to said keratinous fiber.

33. The method according to claim 23, wherein said keratinous fiber is treated for about 5-15 minutes.

34. The method according to claim 23, wherein said keratinous fiber is treated for about 5-10 minutes.

35. The method according to claim 23, wherein the time needed to achieve the desired styling effect is reduced by up to 67% compared to traditional styling methods.

36. The method according to claim 23, wherein said 360° ultrasonic brush rod device utilizes a mechanism comprising of a conductive sheath around the center cylinder upon which microtransducers are affixed thus allowing for the free rotation of said 360° ultrasonic brush rod device around the center cylinder.

37. The method according to claim 36, where ultrasonic transmittance can be achieved without causing any winding of keratinous fibers about the device.

38. The method according to any one of claims 36 and 37, wherein said mechanism may be locked or unlocked by discretion giving the device a duality of function.

39. A 360° ultrasonic brush rod device comprising comprises multiple transducers acoustically coupled to a multitude of appurtenances distributed across the surface of the cylindrical rod arranged to produce a converging treatment region in 360° relative to the rod axis.

40. An ultrasonic brush device comprising multiple acoustically-coupled articulations.
